(19) United States
(12) Patent Application Publication
(10) Pub. No.: US 2006/0125633 A1
(43) Pub. Date: Jun. 15, 2006

(54) Electronic distancing alert system and a process for generating phase synchronism

(76) Inventor: Jose Wilson Pereira Filho, Sao Paulo (BR)

Correspondence Address: TRASK BRITT, P.O. BOX 2550, SALT LAKE CITY, UT, 84110, US

(21) Appl. No.: 10/535,633

(22) PCT Filed: Nov. 21, 2002
(86) PCT No.: PCT/BR02/00159

§ 371 Date: Jan. 9, 2006

(51) Int. Cl. G08B 21/00

(52) U.S. Cl. 340/540

(57) ABSTRACT

One describes an electronic distancing alert system comprising: (i) a transmitting unit (10) positioned on a first body and comprising an encoder (13) associated with a signal modulating and transmitting circuit (14); and (ii) a receiving unit (20) positioned on a second body and comprising a signal receiving and demodulating circuit (24) associated with a decoder (23); the encoder (13) and the signal modulating and transmitting circuit (14) generating and transmitting an identifying code associated with a carrier wave, the identifying code being received by the receiving and demodulating circuit (24) and recognized by the decoder (23), which actuates a triggering circuit (27) upon distancing between the first body and the second body and absence of reception of the identifying code, the encoder (13) generating a plurality of identifying codes combinable with a plurality of different generation frequencies, which are transmitted and received in different fractions of time and in phase synchronism between the transmitting unit (10) and the receiving unit (20). It is also described a process of generating phase synchronism between a transmitting unit (10) and a receiving unit (20) of an electronic distancing alert system, the process comprising the following steps: A) positioning the transmitting unit (10) and the receiving unit (20) connected and close to each other, B) closing a key (CH1) for a determined period of time; C) actuating a memory circuit (25); D) opening the key (CH1).

The present invention relates to an electronic system capable of generating a sound, visual and/or sensitive alarm, whenever a determined pre-established distance between the transmitting unit and the receiving unit that integrate it becomes longer than the maximum limit established and initially programmed, and further to a process of generating phase synchronism between the transmitting unit and the receiving unit.

### DESCRIPTION OF THE PRIOR ART

Alert and alarm devices provided with at least a transmitting element and a receiving element for transmitting and receiving signals emitted by radio frequency are known from the prior art. Many of these devices trigger an alarm whenever there is an interruption or imposition of a barrier on the sharing signals between the transmitter and the receiver. Such devices are much used for protecting vehicles. However, other devices emit an alert whenever a determined pre-established limit of maximum distance between the transmitter and the receiver is exceeded. This type of alert device is used so that a transmitting element can be in the possession of the user, while a receiving element is positioned close to a handbag, work bag, another individual or even a vehicle. Its function is to alert the user when ever the object or individual bearing the receiving element is outside the preestablished distance limit. In this way, this device alerts the user about a possible theft of forgetting of a personal object.

Documents GB 1 520 196 and GB 2 071 956 make reference to electronic alarm devices comprising a signal transmitting element and a signal receiving element, wherein receiver Is programmed for generating a sound or visual alert when the distance between these elements becomes longer than a maximum pre-established distance. However, these devices present problems with regard to their functioning range, because, in order to provide continuous monitoring of the distance established between the transmitter and the receiver, this device has to remain continuously on, which entails an excessive consumption of energy and provides a very restrict utilization of the product itself. Another advantage observed in these devices refers to the problem of interference between two or more independent pieces of equipment that are simultaneously used. This problem impairs the large-scale production of the equipment, since it triggers the alarm unnecessarily by the mere proximity with the other device, that is to say, the signals from one equipment interferes with a second equipment, because these devices do not have any means for differentiating the signals exchanged between different apparatus, except for a change in transmission and reception frequency.

Document U.S. Pat. No. 4,260,982 discloses an alarm system triggered by pulse modulation, producing an alert when the distance between the signal transmitting element and the signal receiving element exceed a predetermined maximum limit. Although the described system presents emission of coded signals, in order to over come the problem of interference with other similar systems, this coding is the same for all the pieces of equipment produced. Therefore, it is necessary for the receiver to have a frequency adjustment circuit, since the frequencies of the signals emitted by the transmitters of several different systems are varied, so as not to return to the problem of interference.

Moreover, in this system the problem of high consumption of energy for a short time of use of the equipment still remains, which results in a short range.

Although document GB 2 112 600 makes reference to an alarm system that is triggered whenever the maximum determined distance between the transmitting element and the receiving element is exceeded, in this system the transmitter and the receiver transmits and receives signals, generating a high consumption of energy and, consequently, a short range of use.

### OBJECTIVES OF THE INVENTION

One objective of the present invention is to provide an electronic distancing-alert system, which is triggered whenever a determined pre-established maximum distance between a transmitting unit and a receiving unit is exceeded, providing low consumption of energy, providing a very long range of use.

Another objective of the present invention is to provide optimum phase synchronism between the transmitting unit and the receiving unit, and further to enable one to use one or more devices, without any interference or mixture of the transmitted and received signals occurring.

### BRIEF DESCRIPTION OF THE INVENTION

The objective of the invention is to provide an electronic distancing-alert system comprising:

(i) a transmitting unit positioned on a first body and comprising an encoder associated with a signal modulating and transmitting circuit; and

(ii) a receiving unit positioned on a second body and comprising a signal receiving and demodulating circuit associated with a decoder; the encoder and the signal modulating and transmitting circuit generating and transmitting an identifying code associated with a carrier wave, the identifying code being received by the receiving and demodulating circuit and recognized by the decoder that actuates the triggering circuit when the first body moves away from the second body and upon absence of the identifying code, the encoder then generates a plurality of identifying codes combinable with a plurality of different generation frequencies, which are transmitted and received in different fractions of time and in phase synchronism between the transmitting unit and the receiving unit.

The present invention also relates to a process of generating phase synchronism between a transmitting unit and a receiving unit of an electronic distancing-alert system, the process comprising the steps of:

A) positioning the transmitting unit and the receiving unit connected and close to each other;

B) closing a key for a determined period of time;

C) actuating the memory circuit; and

D) opening the key.

### BRIEF DESCRIPTION OF THE DRAWING

The present invention will now be described in greater detail with reference to an embodiment represented in the drawings, in which:

FIG. 1 is a block diagram of the transmitting unit that composes the electronic distancing-alert system of the present invention;

FIG. 2 is a block diagram of the receiving unit that composes the electronic distancing-alert system;

FIG. 3 is a diagram of the electronic circuit that composes the transmitting unit illustrated in FIG. 1;

FIG. 4 is a diagram of the electronic circuit that composes the receiving unit illustrated in FIG. 2; and

FIG. 5 is a diagram of the output signal of the decoder present in the receiving unit.

### DETAILED DESCRIPTION OF THE FIGURES

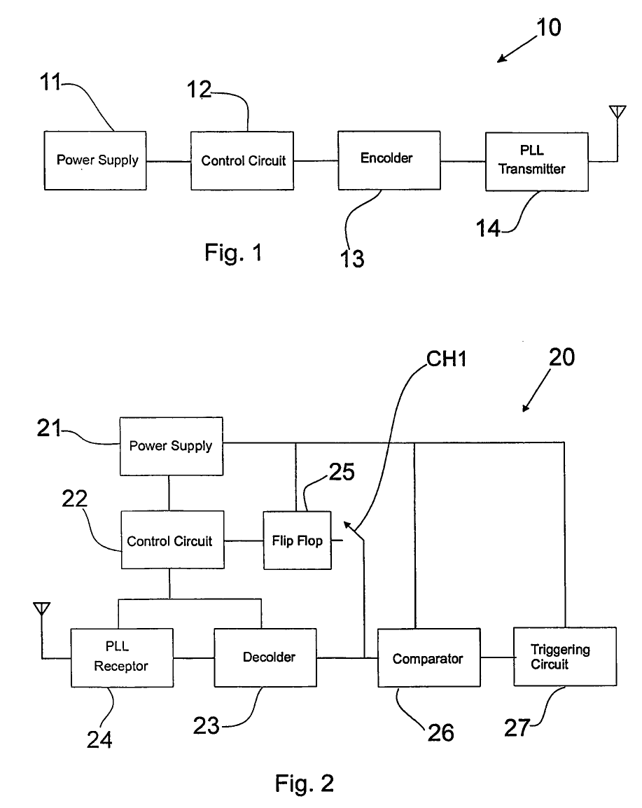

According to a preferred embodiment and as can be seen in FIGS. 1 and 2, the electronic distancing-alert system of the present invention comprises a transmitting unit 10 and a receiving unit 20.

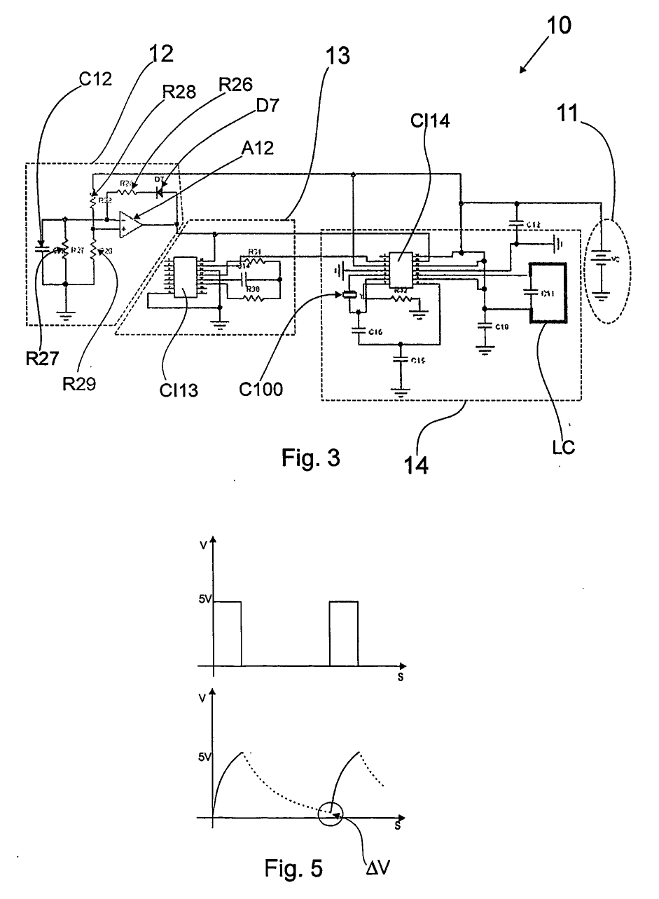

As illustrated in FIG. 1 and 3, the transmitting unit 10 comprises a first power supply 11, for example, a CR 2032-type of Li/MnO₂ battery with nominal voltage of 3V and an average functioning capacity of 225 mAh, which feeds a first control circuit 12.

The control circuit 12 has the function of generating non-symmetric square waves and maintaining the transmitting unit 10 on, while the alert system remains turned on. It is formed by an operational micropower amplifier A12 connected to two resistors R28 and R29 and a capacitor C12. The resistors R28 and R29 are connected in series and act as dividers of the input voltage. In this way, the positive pole of the amplifier A12 is fed with a fixed 1.5 V voltage, whereas the inverter (negative) pole is fed with a varying voltage.

When this varying voltage corresponds to a voltage lower than 1.5 V, the logic level at the output of the amplifier A12 is equal to 1 (one) and the capacitor C12 is charged by re-feeding a diode D7 and a resistor R26. However, when the voltage at the inverter pole is higher than 1.5 V, the logic level at the output of the amplifier 12 is equal to 0 (zero) and the capacitor C12 is discharged through a resistor R27. In this way, the control circuit 12 works as an oscillator, generating asymmetric square waves.

Although this control circuit 12 remains turned on during the whole period of functioning of the alert system, its consumption of energy is of about 10 μA, which provides a useful life of the battery on the order of thousands of hours.

Once the square wave has been generated, it is transmitted to a encoder 13, which is associated with the control circuit 12.

The encoder 13 comprises a trinary integrated circuit CI13, which may have, for instance, nine ports for configuration of the code, if it is the 145026 model. When assembling the alert system, some of the ports of this integrated circuit CI13 are chosen and enabled, generating a determined serial identifying code. This means that this alert system will function, while generating the same identifying code.

When assembling the second alert system, another combination of enabled ports will be chosen, providing the generation of a new identifying code, different from the first one. A new combination of enabled ports is made when assembling the third alert system and so on.

Since with each new combination of enabled ports in the integrated circuit CI13, a different identifying code will be formed, the probability of interference occurring during the simultaneous functioning of various alert systems, due to the coincidence of identifying codes, is very small, considering that the model of integrated circuit CI13 cited as an example is capable of generating 39 different identifying codes. The utilization of other models of integrated circuit CI13 that enable one to generate a greater number of different identifying codes is also foreseen.

The identifying code corresponds to a pulse train that is generated at a determined generation frequency, which results in a pulse train having a determined duration in time. Just like the codes, this frequency may also be different from a system to another, further reducing the probability of interference occurring. For instance, an alert system operates with a determined identifying code, always generated at a frequency equal to 1 KHz. If this system is in the same environment as another system that operates with an identifying code identical to the first one, but generated at a frequency equal to 2 KHz, there will be no interference between these two systems, although the codes are identical. This is because their respective receiving units 20 are adjusted to operate with their determined identifying codes at their determined frequencies, since the referred-to pulse train will have a different duration in time in the two cases exemplified above.

Once the identifying codes have been generated, they are transmitted to a signal modulating and transmitting circuit 14, called PLL transmitter 14.

The PLL (Phase Locked Loop) transmitter 14 is a totally integrated UHF transmitter having low power. Its function is to modulate the signal and transmit it by means of radio frequency (RF). It is formed by an integrated circuit C14; so it has a reduced size, optimizing the space of the transmitting unit 10 and decreasing the occurrence of interference. Its low cost makes it use feasible in the production of alert systems on a large scale.

The PLL transmitter 14 has advantages if compared with a traditional circuit, formed by a modulating component connected to another transmitting component. The first advantage lies in the transmission of the carrier wave, since the integrated circuit CI14 has a BAND pin, the function of which is to select the transmission frequency (f_{R Fout}) of the carrier wave. This is done by varying the voltage level that feeds this BAND pin between 0V (zero Volt) and VCC, that is to say, 3V.

Thus, the output frequency of the PLL transmitter 14 will be determined by the expression:
f_{RFout}=f_{crystal}×divider
wherein f_{crystal} corresponds to the frequency of the crystal oscillator C100 (FIG. 3), which may be of 9.84 MHz or 13.56 MHz. The crystal oscillator C100 may be of the NDK NX1255GA type or NDK NX8045GB type, SMD packaging or another compatible type. The divider corresponds to an increase in the output frequency, which may be of 32 times when the voltage applied to the BAND pin is equal to VCC or 3V, or 64 times when the voltage applied to the BAND pin is equal to zero.

Therefore, considering the expression cited above and choosing level 1 (3V) as the input voltage on the BAND pin, we will have the following options of output frequencies for the carrier wave:
f_{R Fout}=13.56 MHz×32=434 MHz→when using the 13.56 MHz crystal; and a)
f_{R Fout}=9.84 MHz×32=315 MHz→when using the 9.84 MHz. b)
On the other hand, choosing level 0 (0V) as the input voltage on the BAND pin, we will have the following options of output frequencies for the carrier wave:
f_{R Fout}=13.56 MHz×64=868 MHz. c)

Thus, it is clear that, in function of the voltage value applied to the BAND pin, the frequency of the crystal C100 oscillator is multiplied by 32 or 64.

Unlike the systems found in the prior art, the frequency chosen to be used by the distancing-alert system of this invention is of 434 MHz, since this is a free frequency that is within the ham radio range.

The second advantage of the PLL transmitter 14 is associated with the modulation of the signal. The integrated circuit CI14 has a MODE pin with the function of selecting the type of data modulation, which may be either OOK (On Off Keying) or FSK (Frequency Shift Keying).

Furthermore, a third advantage of the PLL transmitter 14 lies in the presence of the ENABLE pin in the integrated circuit CI14, which controls the condition of the PLL, which may be wait condition or functioning condition. In the wait condition, the consumption of the battery is minimum and no data is modulated or transmitted.

By means of the ENABLE pin, the control circuit 12 maintains the PLL transmitter 14 in a wait condition during 985 ms (milliseconds) and in functioning condition for 15 ms in the total time of 1 second. The consumption of energy of the power supply 11 is extremely low, enabling the alert system to have a range of use much longer than that of other similar electronic systems.

Further with regard to the PLL transmitter 14, the LC circuit is present in the step of transmitting the signal and has the function equivalent to that of an antenna, but allowing one to maintain the reduced size of the transmitting unit 10.

Once transmitted by the transmitting unit 10, the signal is received by the receiving unit 20.

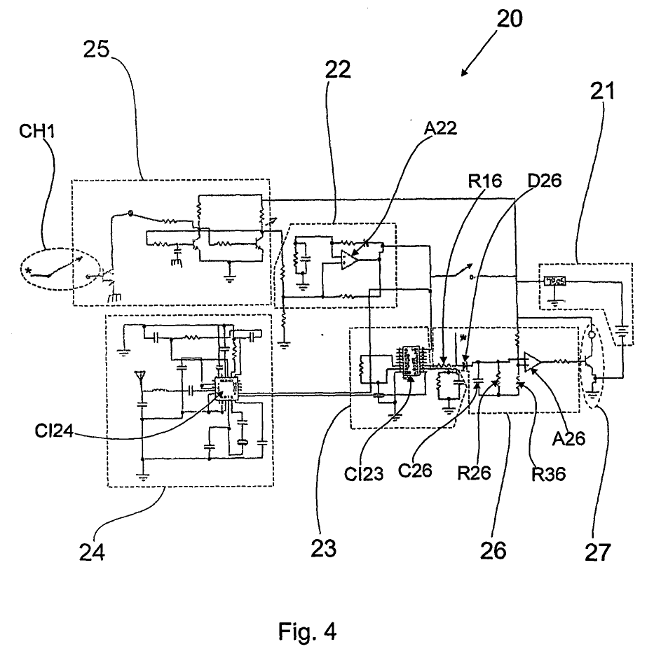

As illustrated in FIGS. 2 and 4, the receiving unit 20 comprises a second power supply 21, which directly feeds a second control circuit 22, a memory circuit of the flip-flop chip 25, a comparator 26, a alert triggering circuit 27, a decoder 23 and a signal receiving and demodulating circuit 24. The second power supply may be, for example, a battery with nominal voltage 12V.

The second control circuit 22 controls the signal receiving and demodulating circuit 24, called PLL receptor 24, and the decoder 23. This control circuit 22 is formed by an operational amplifier A22. Its functioning is identical to that of the first control circuit 12 already described.

The signal is received by the PLL receptor 24, which is compatible with the PLL transmitter 14, arranged in the transmitting unit 10.

Just as the PLL transmitter 14, the PLL receiver 24 also comprises an integrated circuit CI24 equivalent and complementary to the integrated circuit CI14 of the PLL transmitter and that aggregates two functions in a single component, that is to say, it has the function of receiving and demodulating or filtering the signal. In this way, by means of its signal-receiving system adjusted to operate at the same frequency as the PLL transmitter 14, the PLL receiver 24 receives the transmitted signal and, according to the adjustment of its demodulation system, filters the signal, which may have been received in the OOK mode or FSK mode.

The integrated circuit CI24 is provided, among others, with an ENABLE pin, which controls the condition of the PLL receiver 24, which may be a wait condition and a functioning condition. In this way, by means of the ENABLE pin, the second control circuit 22 keeps the PLL receiver 24 functioning for only 10 ms (milliseconds) in the total time of 1 second. Also in the case of the receiving unit, the consumption of energy of the power supply 21 is extremely low, which enables the alert system to have a range much longer that that of other similar electronic systems.

Once the signal has been received and filtered (demodulated), it is transmitted to the decoder 23, the function of which is to recognize the sequence of the identifying code, which has been pre-established by the encoder 13 in the transmitting unit 10. For this purpose, the decoder 23 corresponds to an integrated circuit CI23 compatible with the integrated circuit CI13 of the encoder 13, and should be adjusted, so that it can recognize the predetermined and transmitted identifying code.

Thus, if the recognition by the CI23 is positive, that is to say, if the identifying code is received and corresponds to that predetermined one, a positive signal (5V) is obtained at the output of the decoder 23, as illustrated in FIG. 5. On the other hand, if the recognition is negative, that is to say, if the code is not received or else if it is received but is not the correct code, a null signal, i.e., a logic level 0 (zero) is obtained at the output of the decoder 23.

The signal obtained at the output of the decoder 23 is then transmitted to the flip flop 25, if the key CH1 is closed, and to the comparator 26 by means of the circuit RC. In this case, whenever the identifying code is received and is correct, one obtains a level of 5V for about 10 ms each second, the output remaining at zero for the rest of the time.

The comparator 26 is formed by an operational open-mesh amplifier A26 connected to a first middle-resistance resistor R16, a second resistor R26 with resistance value higher than that of the first resistor R16 and a third resistor R36, the resistance value of which will be calculated in order to maintain a control voltage equal to ΔV at the non-inverting input of the amplifier A26. Further forming the comparator 26, a capacitor C26 and a diode D26 are foreseen.

The circuit of the comparator 26 is mounted in such a way, that the middle-resistance resistor R16 will allow the capacitor C26 to be rapidly charged, whereas the high-resistance resistor R26 causes the capacitor C26 to be slowly discharged. The function of the diode D26 is to prevent the discharge of the capacitor C26 from being effected by means of the resistor R16, since the latter has a resistance value lower than that of the resistor R26.

Thus, and as illustrated in FIGS. 4 and 5, the amplifier A16 receives, at one of its poles, the control voltage ΔV and compares the input voltage in its other pole, which comes from the circuit RC formed by the resistors R16 and R26 and by the capacitor C26. If the voltage level at the pole of the operational amplifier A26, which is connected to the circuit RC, drops, due to the discharge of the capacitor C26, to a value lower than that of the voltage ΔV that feeds the other pole of the amplifier A26, one obtains a logic level 1 (5V) at the output of the operational amplifier A26 and, as a result, the alert triggering circuit 27 is actuated. On the other hand, if the voltage level at the pole of the operational amplifier A26, which is connected to the circuit RC, does not drop to a value lower than ΔV, one obtains a logic level 0 (zero) at the output of the amplifier A26, and the alert triggering circuit 27 will not take place.

Considering that the transmitting unit 10 will be transmitting signals in the period of 15 ms each second and that the receiving unit 20 will be receiving signals in the period of 10 ms each second, in order for the distancing alert system to operate satisfactorily the transmitting unit 10 and the receiving unit 20 must necessarily work in phase synchronism.

Thus, whenever the user turns on the alert system, the transmitting unit 10 and the receiving unit 20, a phase synchronism must be generated between these units by means of a process having the following steps:

A) positioning the transmitting unit 10 and the receiving unit 20 connected and close to each other;

B) turning of a key CH1 for a determined period of time;

C) actuating the memory circuit 25;

D) opening the key CH1.

When the second power supply 21 of the receiving unit 20 is turned on, it does not feed directly the PLL receiver 24 and the decoder 23, as illustrated in FIG. 2. So, in a first moment the second control circuit 22 is at fixed logic level 0 (zero), that is to say, it will not change conditions due to the memory circuit 25, herein called flip-flop circuit.

After step A, a button (not shown) on the receiving unit should be maintained actuated (pressed) for about 3 seconds, maintaining the key CH1 (FIGS. 2 and 4) closed for the same period of time (step B).

This step B enables or turns on the PLL receiver 24 and the decoder 23, since, when the button and, consequently, the key CH1 is kept closed for about 3 seconds, the PLL receiver 24 receives the signal and along with it the identifying code from the transmitting unit 10 at least once and filters this identifying code, sending it later to the decoder 23, where it will finally be recognized.

The signal obtained at the output of the decoder 23 is transmitted to the flip-flop circuit 25, which alerts its logic level at the output, actuating the control circuit 22. In this way, the step C is initiated.

Once the step B has been completed and the step C has been initiated, the transmitting unit 10 enters in phase synchronism with the receiving unit 20, which means that, whenever the transmitting unit 10 is operating to transmit signals, the receiving unit 20 is also simultaneously operating to receive signals.

As already mentioned, the transmitting unit 10 will be functioning in the period of 15 ms each second, whereas the receiving unit will be functioning in the period of 10 ms each second.

The flip-flop circuit 25 may be called memory circuit because it stores one information bit, which is necessary to keep the control circuit 22 functioning.

When the button is released, the step D begins, that is to say, the key CH1 is automatically opened, and the flip-flop circuit and the control circuit 22 will be in charge of maintaining the operation of other components. Possible successive actuations of this button will not produce any effects on the system, since the flip-flop circuit 25 has already stored the information that will maintain the rest of the unit functioning. In order to deactivate or “erase” the signal stored in the flip-flop 25, it is enough to turn off the battery 21 of the receiving unit 20. However, the process of generating phase synchronism between the transmitting unit 10 and receiving unit 20 should be repeated whenever the alert system is turned on.

Once the alert system has already been put in phase, the transmitting unit 10 is positioned on a first body, for example, a travel bag, and the receiving unit is positioned on a second body different from the first one, for example, the user. Each second, the transmitting unit 10 transmits signals with identifying codes to the receiving unit 20. If these identifying codes arrive and are recognized by the receiving unit 20, the triggering circuit 27 is not actuated. If the user moves away from his travel bag a distance in which one cannot receive the identifying codes any longer, the alert triggering circuit 27 is actuated. This alert may be auditory, visible or perceived by contact, as for instance by vibration.

Thus, in order for the electronic distancing alert system in question to be satisfactorily used, some conditions have to be met, namely:

a) The identifying code received by the decoder 23 mounted on the receiving unit 20 will have to be the same one transmitted by the transmitting unit 10, so that the latter can be recognized by said decoder 23. As already mentioned, this fact renders it difficult to mix signals from two or more alert systems, which may be used in conjunction, that is to say, it makes the occurrence of interference difficult.

b) Both the identifying code generated and transmitted and the identifying code received and decoded will be at the same frequency. This fact will also help in preventing interference, since, independently of the frequency of the carrier wave (which will be constant), each encoder 13 will generate a code at a determined frequency, and the receiving unit 20 will receive only the one that is compatible, through the decoder 23.

c) The transmitting unit 10 and the receiving unit 20 have to be in phase synchronism, that is to say, although the transmitting unit 10 and the receiving unit 20 remain operating during different periods of time (15 ms each second for the transmitting unit 10 and 10 ms each second for the receiving unit 20), the transmitting operation has to be simultaneous with the receiving operation, i.e., when the transmitting unit 10 is operating and transmitting signals, the receiving unit 20 should also be operating to receive these signals. This bring about the advantage of enabling one to use various alert systems simultaneously, without there being interference on the signals transmitted and received by these systems. This is because, although all of them are used at the same transmission and reception frequency (carrier wave), their respective transmitting unit 10 and receiving unit 20 will be in phase with each other and will only emit and receive the signals in phase.

d) The distance between the transmitting unit 10 and the receiving unit 20 should be within the maximum pre-established limit in function of the range in range in transmitting and receiving the signals. As already mentioned, if the distance between the transmitting unit 10 and the receiving unit 20 exceeds the maximum established limit, no reception of signal will take place, and the levels of voltage of the system drop below the control voltage ΔV, causing the alert triggering circuit 27 to be actuated and the alert to be emitted.

A preferred embodiment having been described, it should be understood that the scope of the present invention embraces other possible variations, being limited only by the contents of the accompanying claims, which include the possible equivalents.

1. An electronic distancing alert system comprising:
(i) a transmitting unit (10) positioned on a first body and comprising an encoder (13) associated with a signal modulating and transmitting circuit (14); and
(ii) a receiving unit (20) positioned on a second body and comprising a signal receiving and demodulating circuit (24) associated with a decoder (23);
the encoder (13) and the signal modulating and transmitting circuit (14) generating and transmitting an identifying code associated with a carrier wave, the identifying code being received by the receiving and demodulating circuit (24) and recognized by the decoder (23), which actuates a triggering circuit (27) upon distancing between the first body and the second body and absence of reception of the identifying code, the electronic distancing alert system being characterized in that:
a) the encoder (13) generates a plurality of identifying codes combinable with a plurality of different generation frequencies, which are transmitted by the transmitting unit (10) and received by the receiving unit (20),
b) the transmitting unit (10) and the receiving unit (20) being selectively and phase-synchronously switched on by a first control circuit (12) which controls the condition of a PLL transmitter (14) and a second control circuit (24) which controls the condition of a PLL receptor (24) for a transmitting period, and turned inoperable by the first control circuit (12) and the second control circuit (22) during the remaining period,
c) the receiving unit (20) being turned on prior to the transmitting unit (10) and the turned off after the transmitting unit (10) during the transmitting period, such that, the transmission of the plurality of identifying codes is transmitted by the transmitting unit (10) during the transmitting period.

2. A system according to claim 1, characterized in that the encoder (13) comprises an integrated circuit (CI13) provided with means of generating serial identifying codes.

3. A system according to claim 2, characterized in that the means of generating identifying codes comprise multiple combinations of enabled logic ports.

4. A system according to claim 3, characterized in that, at each combination of enabled logic ports, a different several identifying code is generated at a determined frequency.

5. A system according to claim J, characterized in that the signal modulating and transmitting circuit (14) comprises an integrated circuit (CI14) associated with a crystal oscillator (C100).

6. A system according to claim 5, characterized in that the signal modulating and transmitting circuit (14) modulates the identifying code to the carrier wave and transmits it at a free frequency.

7. A system according to claim 6, characterized in that the carrier wave is transmitted at a frequency of 434 MHz.

8. A system according to claim 7, characterized in that the carrier wave is transmitted by means of radio frequency.

9. A system according to claim 1, characterized in that the transmitting unit (10) comprises a first control circuit (12) associated with a power supply (11).

10. A system according to claim 9, characterized in that the control circuit (12) actuates the signal modulating and transmitting circuit (14), which transmits the identifying code in a fraction of time corresponding to 15 ms each 1 second.

11. A system according to claim 9, characterized in that the power supply (11) is a battery with nominal voltage of 3V.

12. A system according to claim 1, characterized in that the receiving and demodulating circuit (24) comprises an integrated circuit (CI24) operating at the same frequency as the modulating and transmitting circuit (14).

13. A system according to claim 12, characterized in that the receiving and demodulating circuit (24) receives data transmitted by the transmitting unit (10) and filters the identifying code from the carrier wave.

14. A system according to claims 1, characterized in that the decoder (23) comprises an integrated circuit (CI23) compatible with the integrated circuit (CI13) of the encoder (13) of the transmitting unit (10).

15. A system according to claim 14, characterized in that the decoder (23) identifies the presence and recognizes the identifying code transmitted by the transmitting unit (10), generating an output signal of positive logic level.

16. A system according to claim 14, characterized in that the decoder (23) identifies the absence and non-recognition of the identifying code transmitted by the transmitting unit (10), generating an output signal of null logic level.

17. A system according to claim 15, characterized in that the signal obtained at the output of the decoder (23) is transmitted to a comparator (26), which is associated with the alert triggering circuit (27).

18. A system according to claim 17, characterized in that the comparator (26) comprises a separation means between the first control voltage (ΔV) and a second varying voltage.

19. A system according to claim 18, characterized in that the comparison means corresponds to an electronic circuit (26) comprising an operational amplifier (A26) associated with a first resistor (R16) provided with an average resistance value, to a second resistor (R26) provided with a resistance value higher than that of the first resistor (R16), to a third resistor (R36) provided with a resistance value calculated from the control voltage (ΔV), to a capacitor (C26) and to a diode (D26).

20. A system according to claim 19, characterized in that the positive signal at the output of the decoder (23) charges the capacitor (C26), and the second varying voltage received by the comparator (26) is higher than the control voltage (ΔV).

21. A system according to claim 20, characterized in that the capacitor (C26) is charged by the first resistor (16) by means of a first potential difference generated by the decoder (23).

22. A system according to claim 19, characterized in that the null signal at the output of tile decoder (23) discharges the capacitor (C26), and the second varying voltage received by the comparator (26) is lower than the control voltage (ΔV).

23. A system according to claim 22, characterized in that the capacitor (C26) is discharged by means of the resistor (R26).

24. A systems according to claim 23, characterized in that the comparator (26) actuates the alert triggering circuit (27) when the second varying voltage is lower than the control voltage (ΔV).

25. A system according to claim 1, characterized in that the receiving unit (20) comprises a second control circuit (22) associated with a power supply (21).

26. A system according to claim 25, characterized in that the control circuit (22) actuates the signal receiving and demodulating circuit (24), which receives the identifying code in a fraction of time corresponding to 10 ms each 1 second.

27. A system according to claim 25, characterized in that the power supply (21) is a battery with nominal voltage of 12V.

28. A system according to claim 1, characterized in that the receiving unit (20) comprises a memory circuit (25) associated with the decoder (23) by means of a key (CH1) and associated with the control circuit (22).

29. A system according to claim 28, characterized in that the actuation of the memory circuit (25) provides the phase synchronism between the transmitting unit (10) and the receiving unit (20).

30. A process of generating phase synchronism between a transmitting unit (10) and a receiving unit (20) of an electronic distancing alert system, the process comprising the steps of:
A) positioning the transmitting unit (10) and the receiving unit (20) turned on and close to each other;
B) actuating a button on the receiving unit (20) maintaining a key (CH1) closed for a determined period of time;
C) enabling a PLL receiver (24) on the receiving unit (20) to receive a signal with a identifying code from the transmitting unit (10) sending the signal to a decoder (23);
the process of generating phase synchronism between a transmitting unit (10) and a receiving unit (20) of an electronic distancing alert system being characterized in that it also comprises the following steps:
D) transmitting a signal obtained at the output of the decoder (23) to actuate a memory circuit (25) and synchronizing the receiving unit (20) to be operable synchronizing to the transmitting unit (10), the transmitting unit (10) functioning during a 15 ms period per each second and the receiving unit (20) functioning during 10 ms period per each second;
E) releasing the button on the receiving unit (20) opening the key (CH1).

31. A process according to claim 30, characterized in that in step B, the closing of the key (CH1) maintained for a period of time substantially equal to 3 seconds.

32. A process according to claim 31, characterized in that, in the step of closing the key (CH1), at least one identifying code transmitted by the transmitting unit (10) is received by the receiving unit (20) by means of the signal receiving and demodulating circuit (24) and recognized by a decoder (23), which generates a positive output signal.

33. A process according to claim 32, characterized in that the positive signal generated by the decoder (23) in the step B initiates the step C, actuating the memory circuit (25).

34. A process according to claim 33, characterized in that, during the step C, the memory circuit (25), stores the positive signal generated by the decoder (23) and actuates a second control circuit (22).

35. A process according to claim 34, characterized in that the second control circuit (22) operates in synchronism with a first control circuit (12).
